(19) United States
(12) Patent Application Publication
(10) Pub. No.: US 2025/0162337 A1
(43) Pub. Date: May 22, 2025

(54) LOCALLY MODIFIED WAVEGUIDE TOTAL THICKNESS VARIATION

(71) Applicant: GOOGLE LLC, Mountain View, CA (US)

(72) Inventors: Wei Jin, Saratoga, CA (US); Lu Tian, Palo Alto, CA (US); Kang Luo, San Jose, CA (US); Nai-Wen Pi, Cupertino, CA (US); Thomas Mercier, Weston, FL (US)

(21) Appl. No.: 18/515,631

(22) Filed: Nov. 21, 2023

(51) Int. Cl. B41M 5/00; B41M 3/00; G02B 6/34

(52) U.S. Cl. CPC B41M 5/0041; B41M 3/003; G02B 6/34; B41M 2205/16

(57) ABSTRACT

Optical waveguides are formed based on measured parameters of an optical substrate. Regions for forming one or more optical elements are identified based on these measurements, and inkjet deposition is utilized to deposit a refraction-matched deposition material is applied to one or more identified regions to selectively modify the total thickness variation (TTV) in each such region. Prior to or subsequent to the deposition, optical gratings or other optical elements are formed within the adjusted regions.

### BACKGROUND

Waveguides play a fundamental role in modern optical systems, with applications spanning from data communication to display technologies. The precise behavior of these waveguides often depends on factors at a micro- and nano-scale, with one important parameter being the Total Thickness Variation (TTV).

In semiconductor manufacturing, TTV influences the performance, reliability, and yield of the integrated circuits produced on the wafer. Substrate manufacturers have developed various techniques aimed at controlling and reducing TTV, such as stress management, precision grinding, and polishing. Achieving uniform device characteristics across the wafer is important to enhance yield and ensure consistent product quality. A controlled TTV ensures that electronic devices made on the wafer operate as intended, with minimal variations in performance.

However, TTV presents a unique challenge in the context of optical waveguides. Contrary to traditional semiconductor devices, in which a flat TTV profile is often desired, certain optical waveguide designs benefit from having a larger TTV in specific areas, such as those in which pupil expanders or other gratings of the waveguide are to be formed. This is due to the coherent effect observed in these waveguides, which can notably amplify pupil efficiency and reduce brightness nonuniformity based on the design. Such performance enhancements are not trivial; for instance, the coherent effect can lead to up to a threefold increase in pupil efficiency and/or a 50% reduction in nonuniformity.

Thus, there is a need for techniques that provide flexibility in locally modifying the TTV of waveguides, such as to alleviate the constraints imposed by current manufacturing practices and offer a path towards improved waveguide optical performance without increasing the complexity of the fabrication process.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a top-down view of a circular optical substrate wafer 100 having a two-dimensional (2D) parabolic profile.

FIG. 2 illustrates a configuration for forming four waveguides from a substantially circular optical substrate wafer, in accordance with some embodiments.

FIG. 3 is an operational flow diagram outlining an operational routine 300 for modifying waveguide TTV using inkjet-based nanoimprint lithography, in accordance with some embodiments.

FIG. 4 illustrates a waveguide fabrication process in which inkjet deposition is performed prior to formation of waveguide gratings, in accordance with some embodiments.

FIG. 5 illustrates a waveguide fabrication process in which inkjet deposition is performed subsequent to formation of waveguide gratings, in accordance with some embodiments.

FIG. 6 illustrates an example wearable display device 600 in accordance with various embodiments.

### DETAILED DESCRIPTION

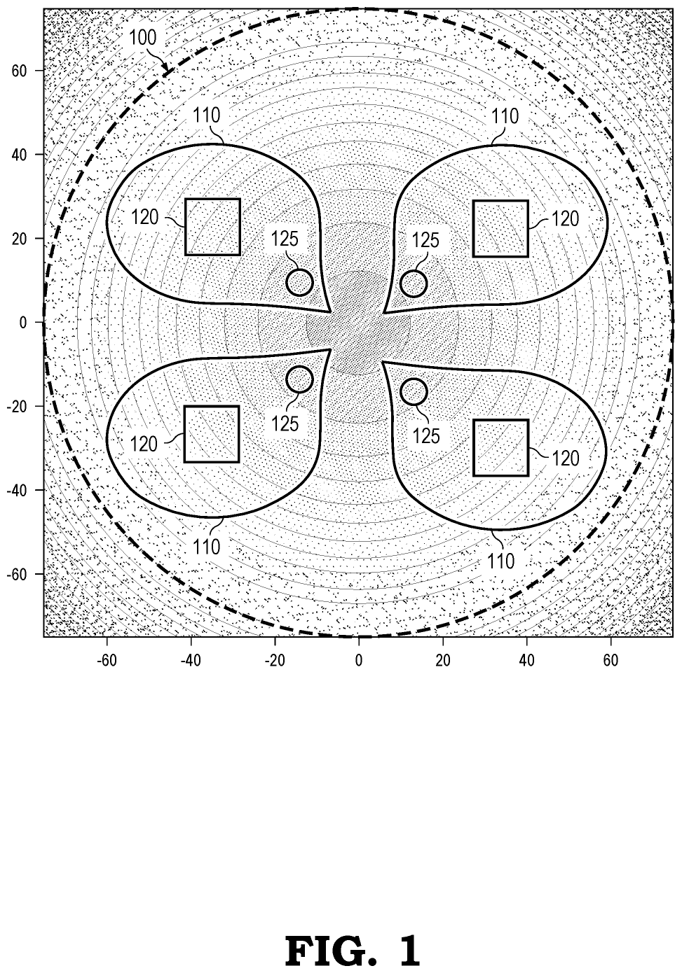

FIG. 1 illustrates a top-down view of a circular optical substrate wafer 100 having a two-dimensional (2D) parabolic profile; variations in tone depicted for the optical substrate wafer 100 illustrate thickness variations of the substrate wafer 100 itself, with the relative thickness being greatest at the center and least at the outer edge of the optical substrate wafer 100.

Because of the dome profile of the optical substrate wafer 100, the arrangement of optical elements to be formed using the optical substrate wafer are arranged to have radial symmetry in order to maintain TTV between individual waveguides (also referred to herein as eyepieces), as well as to maximize benefits from a larger TTV in certain regions in which optical elements (e.g., one or more waveguide gratings pupil expanders, etc.) are to be formed. In the example of FIG. 1, four individual eyepieces 110 are arrayed in a pinwheel configuration, with such arrangement being intended to allow features within each of the eyepieces 110 to possess substantially identical TTV.

Each eyepiece 110 includes a rectangular region designated as the outcoupler grating region 120. Within this region, one or more outcoupler gratings will be formed to guide and redirect light from the waveguide to the viewer's eye or another optical component.

In addition to the outcoupler grating regions 120, each eyepiece 110 also has an elliptical area known as the incoupler grating region 125. In this area, one or more incoupler gratings will be established to couple light into the waveguide, ensuring effective light propagation within the structure. The incoupler grating regions 125 introduce fabrication challenges due to the need for performing multiple lithography-etch steps in order to form the incoupler gratings within those incoupler grating regions 125. The substrate wafer 100 itself presents a demanding task for substrate manufacturers as they have to maintain precise specifications concerning the range and center of the dome for this arrangement.

As indicated above, the choice of a pinwheel configuration for laying out the eyepieces 110 within the optical substrate wafer 100 is designed to benefit from the larger TTV present in the outcoupler grating regions 120 and incoupler grating regions 125. Each eyepiece 110 aligns with the 2D parabolic profile of the substrate wafer 100, ensuring that the coherent effects associated with varying TTV are optimized.

Furthermore, while not explicitly shown in FIG. 1, the depicted configuration presents complexities during the nanoimprint process, especially given the varying angles associated with each eyepiece. For example, the surface angles within the outcoupler incoupler grating regions 125 necessitate four separate lithography-etch steps during fabrication in some cases. Such intricacies can increase the risk of yield loss and add to process complexity.

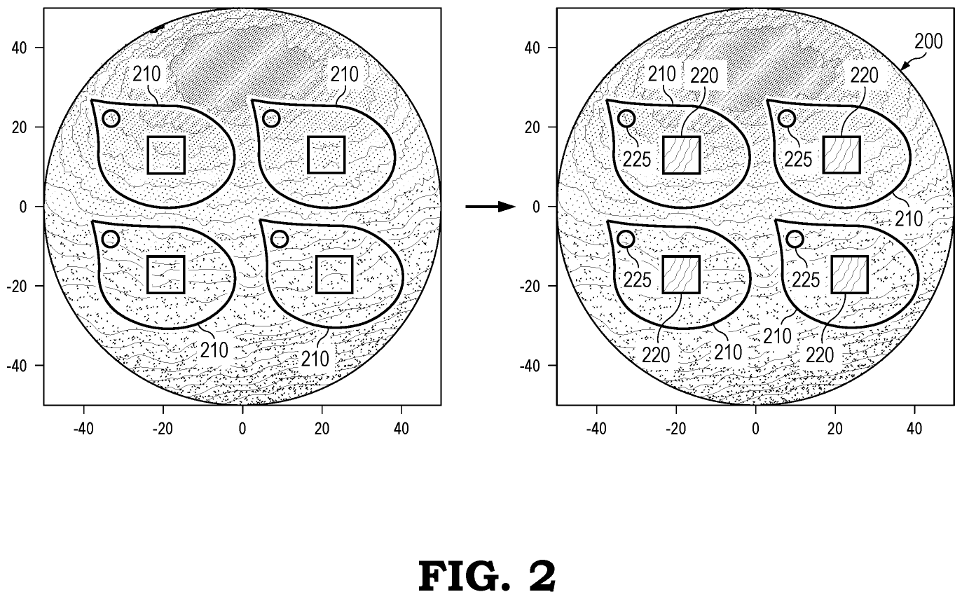

FIG. 2 illustrates a configuration for again forming four eyepieces 210 from a substantially circular optical substrate wafer 200. Notably, the optical substrate wafer 200, as indicated by tonal variations in the depicted example, is not a 2D parabolic profile wafer but intended to be planar (i.e., having a constant TTV across the optical substrate wafer 200). Thus, the tonal variations across the optical substrate wafer 200 again indicate variations in thickness, but are due to manufacturing defects rather than an intended dome shape. Due to this flat profile, no pinwheel arrangement of the eyepieces 210 is utilized in order to guarantee substantially identical TTV profiles for outcoupler grating regions 220. Instead, inkjet-style deposition is utilized to compensate for unintended variations in the TTV of optical substrate wafer 200.

As used herein, inkjet deposition is a process involving controlled ejection of droplets of a deposition material (e.g., functional resin) onto a substrate (e.g., optical substrate wafer 200). This technique precisely deposits the deposition material in a programmable pattern, allowing for specific areas of the substrate to be selectively modified. Inkjet deposition is typically non-contact, meaning that the print head does not physically touch the substrate, making it suitable for delicate or uneven surfaces. Fine details and variations of the deposited material's thickness may be created by adjusting the droplet size, spacing, and quantity of passes over the same area of the substrate. In the context of waveguide fabrication, inkjet deposition is used to locally adjust the TTV of the substrate by applying a resin having a refractive index that is matched with that of the optical substrate, thus enabling precise, localized adjustments to the optical path length within a particular region of the optical substrate (e.g., outcoupler grating regions 220 and incoupler grating regions 225). In various embodiments, such inkjet deposition may be used to adjust the TTV of an optical substrate by an amount typically within 100-800 nm using controlled addition of deposition material.

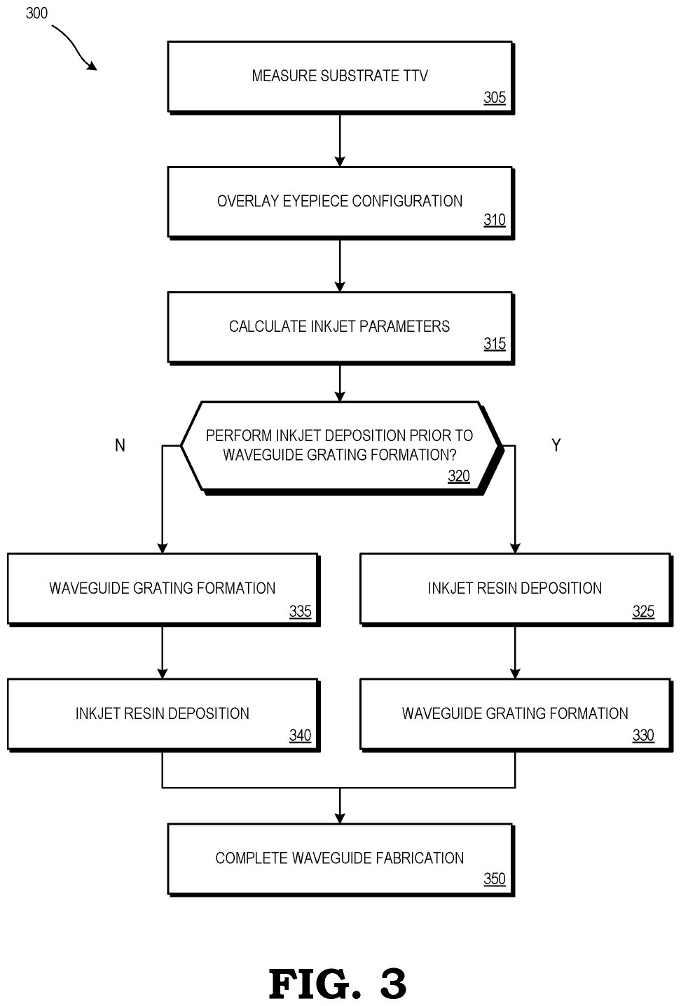

FIG. 3 is an operational flow diagram in accordance with one or more embodiments, outlining an operational routine 300 for modifying waveguide TTV using inkjet-based nanoimprint lithography. The operational routine 300 enhances the optical performance of waveguides by precisely adjusting their TTV. The routine begins at block 305.

At block 305, optical metrology techniques are employed to accurately gauge the TTV of an optical substrate (e.g., optical substrate wafer 200 of FIG. 2). The routine 300 proceeds to block 310.

At block 310, the eyepiece configuration is overlaid onto the substrate. This defines the target TTV profile at specific locations of interest, such as the expander grating regions of the waveguide, and aligns any regions for which TTV is to be modified with optical requirements of the waveguide. The routine proceeds to block 315.

At block 315, the calculation of inkjet parameters takes place. This generally optimizes various parameters for the inkjet deposition, including drop size, drop spacing, and other relevant factors, based on the target profile and the characteristics of the optical substrate. The routine proceeds to block 320.

At block 320, a determination is made regarding whether to perform the inkjet resin deposition before or after the waveguide grating fabrication. This determination allows for a tailored approach based on the specific requirements for the optical waveguide, as well as for the manufacturing process. For example, performing inkjet deposition prior to the waveguide grating formation can result in enhanced surface uniformity, simplified grating fabrication, and greater control over the optical path of the waveguide. Conversely, performing such material deposition after the formation of one or more gratings allows for adjustments and/or corrections based on the actual outcomes of the grating formation process, and can allow for a greater variety of materials while preserving integrity of both the resin deposition and the grating structures.

If it is determined at block 320 to proceed with inkjet deposition first, the routine proceeds to block 325, where the inkjet resin deposition is performed. The application of the deposition material at this stage sets the stage for subsequent grating formation with the modified TTV. After resin deposition, the routine advances to block 330 for the waveguide grating fabrication process. This step involves imprinting the waveguide structure onto the deposition-modified optical substrate, utilizing either nanoimprint lithography or a photolithography process.

If it is determined at block 320 to proceed with the waveguide grating formation prior to inkjet deposition, the routine proceeds to block 335 for the waveguide grating formation first. Subsequently, after the gratings are formed routine 300, the process continues to block 340, in which the inkjet resin deposition is performed. This post-grating inkjet deposition tailors the TTV post-fabrication, offering a different approach to achieving the desired optical characteristics.

Regardless of the inkjet deposition timing, after block 330 or block 340, the routine 300 proceeds to block 350, completing the remaining aspects of waveguide fabrication. In various embodiments and scenarios, such aspects may include finalizing structural details of the waveguide, applying protective coatings or layers, conducting post-fabrication quality checks, singulating the individual eyepieces, and integrating the waveguide into larger optical systems. Specific steps and processes might involve surface treatment and finishing (e.g., additional polishing, cleaning, or chemical treatments to prepare and complete waveguide surfaces); applying protective coatings (e.g., to enhance durability, resistance to environmental factors like moisture and UV radiation, or to improve optical properties of the waveguide); etc.

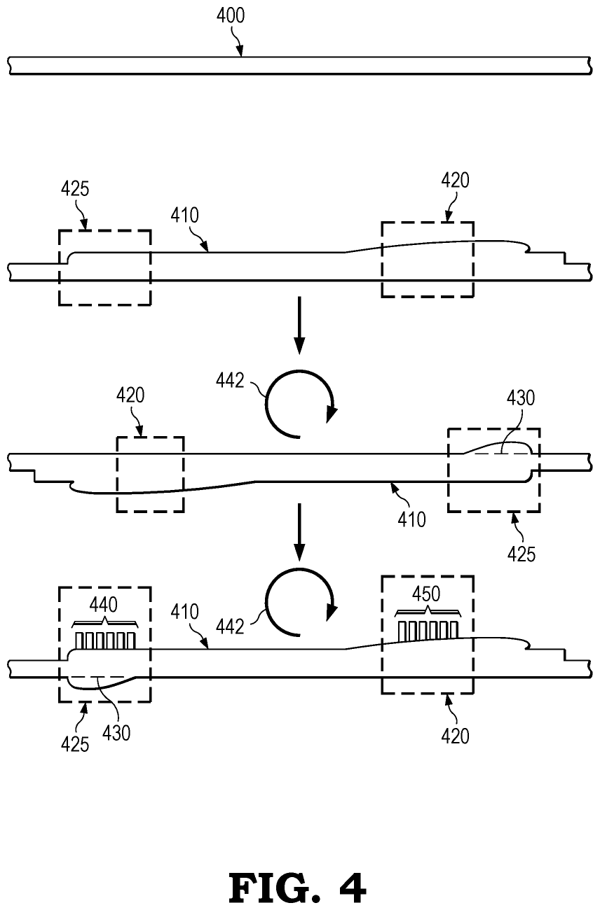

FIG. 4 illustrates a waveguide fabrication process in which inkjet deposition is performed prior to formation of waveguide gratings, in accordance with some embodiments. In the depicted example, an idealized optical substrate wafer 400 is depicted in magnified cross-section, in which the total thickness of the substrate wafer is constant.

The profile of an actual optical substrate wafer 410 is depicted below the idealized optical substrate wafer 400. As is evident from its magnified cross-section, the total thickness variation is significant, such that the thickness of the optical substrate wafer 410 varies substantially depending on the region selected.

In a manner similar to that noted with respect to blocks 305 and 310 of the operational routine 300 in FIG. 3, parameters of the optical substrate wafer 410 are measured and an eyepiece configuration is selected. Due to surface variations of the optical substrate wafer 410, as well as the requirements for the resulting optical waveguide, a first region 420 is selected for the outcoupler grating region, with a second region 425 selected for the incoupler grating region. However, while in the depicted example the thickness of optical substrate material in region 420 is suitable for the intended outcoupler grating optical element, the thickness of that optical substrate material is less than ideal in region 425 for the incoupler grating optical element intended to be positioned there.

As depicted by arrow 422, the optical substrate wafer 410 is inverted and a deposition material 430, a functional resin having a refractive index substantially identical to that of the optical substrate wafer 410, is deposited via inkjet deposition in the region 425.

In the embodiment and example of FIG. 4, and as depicted by arrow 442, the optical substrate wafer 410 is again inverted, and waveguide gratings 440 and 450 are formed in regions 425 and 420, respectively.

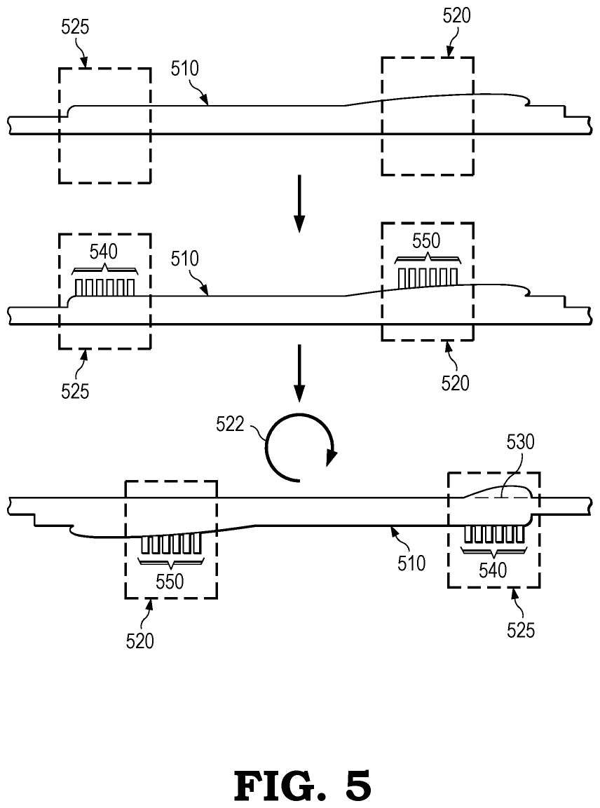

FIG. 5 illustrates a waveguide fabrication process in which inkjet deposition is performed subsequent to formation of waveguide gratings, in accordance with some embodiments. An optical substrate wafer 510 is depicted in magnified cross-section, and is substantially identical to the optical substrate wafer 410 of FIG. 4. Once again, the total thickness variation is significant, such that the thickness of the optical substrate wafer 510 varies substantially depending on the region selected.

Parameters of the optical substrate wafer 410 are measured and an eyepiece configuration is selected. Due to surface variations of the optical substrate wafer 510, as well as the requirements for the resulting optical waveguide, a first region 520 is selected for the outcoupler grating region, with a second region 525 selected for the incoupler grating region. Although the thickness of optical substrate material in region 520 is suitable for the intended outcoupler grating optical element, the thickness of that optical substrate material is less than ideal in region 525 for the incoupler grating optical element intended to be positioned there.

In the embodiment and example of FIG. 5, waveguide gratings 540 and 550 are formed in regions 525 and 520, respectively. Then, as depicted by arrow 522, the optical substrate wafer 510 is inverted and a functional resin 530, which (in a manner similar to deposition material 430 of FIG. 4) has a refractive index substantially identical to that of the optical substrate wafer 510, is deposited via inkjet deposition in the region 520.

It will be appreciated that in various embodiments and scenarios, fabrication of an optical waveguide is performed in manners that differ from the specific example of FIGS. 4 and 5. For example, in certain scenarios the optical substrate wafer is not inverted during the operations described above, such that inkjet deposition and grating formation are performed on the same side of the optical substrate wafer.

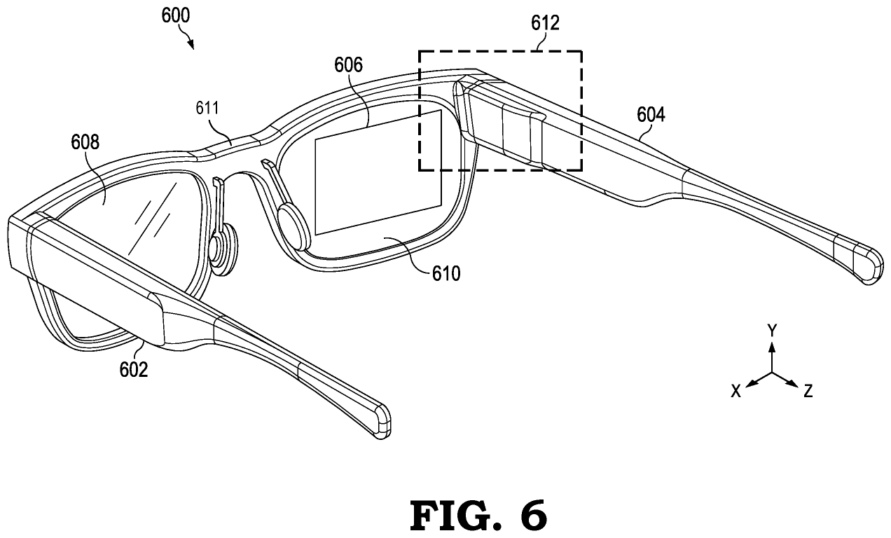

FIG. 6 is a diagram illustrating a rear perspective view of a wearable heads-up display system 600 implementing waveguide with one or more diffractive gratings in accordance with some embodiments. The display system 600 includes a support structure 602 (e.g., a support frame) to mount to a head of a user and that includes an arm 604 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 606 at one or both of lens elements 608, 610 supported by the support structure 602 and using one or more display optics. The display optics may include one or more instances of optical elements selected from a group that includes at least: a waveguide (references to which, as used herein, include and encompass both light guides and waveguides), a holographic optical element, a prism, a diffraction grating, a light reflector, a light reflector array, a light refractor, a light refractor array, or any other light-redirection technology as appropriate for a given application, positioned and oriented to redirect the AR content from the light engine 611 towards the eye of the user. In some embodiments, the support structure 602 further includes various sensors, such as one or more front-facing cameras, rear-facing cameras (e.g., for eye tracking), other light sensors, motion sensors, accelerometers, and the like. The support structure 602 further can include one or more radio frequency (RF) interfaces or other wireless interfaces, such as a Bluetooth™ interface, a WiFi interface, and the like.

The support structure 602 further can include one or more batteries or other portable power sources for supplying power to the electrical components of the display system 600. In some embodiments, some or all of these components of the display system 600 are fully or partially contained within an inner volume of support structure 602, such as within the arm 604 in region 612 of the support structure 602. In the illustrated implementation, the display system 600 utilizes an eyeglasses form factor. However, the display system 600 is not limited to this form factor and thus may have a different shape and appearance from the eyeglasses frame depicted in FIG. 6.

One or both of the lens elements 608, 610 are used by the display system 600 to provide an augmented reality (AR) display in which rendered graphical content can be superimposed over or otherwise provided in conjunction with a real-world view as perceived by the user through the lens elements 608, 610. For example, laser light or other display light is used to form a perceptible image or series of images that are projected onto the eye of the user via one or more optical elements, including a waveguide, formed at least partially in the corresponding lens element. One or both of the lens elements 608, 610 thus includes at least a portion of a waveguide that routes display light received by an incoupler (IC) (not shown in FIG. 6) of the waveguide to an outcoupler (OC) (not shown in FIG. 6) of the waveguide, which outputs the display light toward an eye of a user of the display system 600. Additionally, the waveguide employs an exit pupil expander (EPE) (not shown in FIG. 6) in the light path between the IC and OC, or in combination with the OC, in order to increase the dimensions of the display exit pupil. Each of the lens elements 608, 610 is sufficiently transparent to allow a user to see through the lens elements to provide a field of view of the user's real-world environment such that the image appears superimposed over at least a portion of the real-world environment.

Non-limiting example display architectures could include scanning laser projector and holographic optical element combinations, side-illuminated optical light guide displays, pin-light displays, or any other wearable heads-up display technology as appropriate for a given application. The term light engine as used herein is not limited to referring to a singular light source, but can also refer to a plurality of light sources, and can also refer to a light engine assembly. A light engine assembly may include some components which enable the light engine to function, or which improve operation of the light engine. As one example, a light engine may include a light source, such as a laser or a plurality of lasers. The light engine assembly may additionally include electrical components, such as driver circuitry to power the at least one light source. The light engine assembly may additionally include optical components, such as collimation lenses, a beam combiner, or beam shaping optics. The light engine assembly may additionally include beam redirection optics, such as least one MEMS mirror, which can be operated to scan light from at least one laser light source, such as in a scanning laser projector. In the above example, the light engine assembly includes a light source and also components, which take the output from at least one light source and produce conditioned display light to convey AR content. All of the components in the light engine assembly may be included in a housing of the light engine assembly, affixed to a substrate of the light engine assembly, such as a printed circuit board or similar, or separately mounted components of a wearable heads-up display (WHUD).

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for forming an optical waveguide, the method comprising:
measuring one or more parameters of an optical substrate;
identifying one or more regions of the optical substrate for inkjet deposition based at least in part on the measured optical substrate parameters;
depositing a deposition material to adjust a total thickness variation (TTV) in the one or more regions; and
forming one or more optical grating elements in the one or more regions.

2. The method of claim 1, wherein the depositing of the deposition material is performed prior to the forming of the one or more optical grating elements.

3. The method of claim 1, wherein the depositing of the deposition material is performed subsequent to the forming of the one or more optical grating elements.

4. The method of claim 1, further comprising forming one or more additional optical elements of the optical waveguide.

5. The method of claim 4, wherein the depositing of the deposition material is performed prior to the forming of the one or more additional optical elements.

6. The method of claim 4, wherein the depositing of the deposition material is performed subsequent to the forming of the one or more additional optical elements.
